(19) United States
(12) Patent Application Publication
(10) Pub. No.: US 2008/0223181 A1
(43) Pub. Date: Sep. 18, 2008

(54) Multifunction hand tool for testing backflow prevention devices

(76) Inventor: Sean Cline, Salina, KS (US)

Correspondence Address: THOMPSON & THOMPSON, P.A., P.O BOX 166, SCANDIA, KS, 66966, US

(21) Appl. No.: 11/717,919

(22) Filed: Mar. 13, 2007

(51) Int. Cl. B25B 13/00

(52) U.S. Cl. 81/124.2

(57) ABSTRACT

A multifunction hand tool includes a tubular body having first and second open ends, a front wall, a rear wall, and first and second side walls. A first screwdriver tip protrudes from the rear wall in a longitudinal direction so as to be coplanar with the rear wall. A second screwdriver tip protrudes from the front wall in a lateral direction so as to be perpendicular with the front wall. A socket opening is formed in the front wall for engaging a hexagon-shaped fitting. First and second slots are formed in the first and second side walls, respectively, for engaging a flat handle of a ball valve. A third slot is formed in the rear face for engaging a flat handle of a ball valve. A cutout portion in the tubular body is defined by a removed section of the front wall and the first and second side walls.

### BACKGROUND OF THE INVENTION

1. Field of the Invention

The present invention relates generally to hand tools, and in particular, to multifunction hand tools that are useful for accomplishing a variety of operations necessary to inspect and service backflow prevention devices.

2. Description of the Related Art

Backflow prevention devices are used to protect water supplies from contamination. The purpose of backflow prevention devices is to keep water from flowing backwards through a cross-connection. A cross-connection can be any connection between a public water system (or consumer's potable water system) and any source or system containing nonpotable water or other substances. Without a backflow prevention device, backflow can be caused by backsiphonage or by other conditions in which a pressure downstream of a cross-connection is greater than a pressure in the public water system upstream of the cross-connection. These conditions can be created by high water use in the public water system (e.g., water line breaks, water line flushing, etc.) and by downstream pressure increases (e.g., created by temperature increases, pumps, etc.).

There are several different types of backflow prevention devices. Some of the most common types are pressure vacuum breaker devices, double check assembly devices, and atmospheric vacuum breaker devices. Mechanical backflow preventers have internal seals, springs, and moving parts that are subject to fouling, wear or fatigue. Also, mechanical backflow preventers can be bypassed or installed improperly. Therefore, all backflow preventers have to be tested periodically to ensure that they are functioning properly. Mechanical backflow preventers are typically required to be tested with properly calibrated gauge equipment by certified experts.

Testing mechanical backflow preventers requires a number of parts to be removed and/or rotated. For example, stop cocks (very small ball valves) need to be turned, brass fittings need to be removed, ball valve handles need to be rotated, retainer clips need to be removed, valve box lids need to be opened, and so forth. These operations typically require several different tools to accomplish, including screwdrivers, wrenches, pliers, cheater bars, and so forth. Moreover, these operations are often done in tight quarters with little room to manipulate conventional hand tools.

There is a need in the industry for an improved tool for use by backflow prevention device technicians and other service providers.

### SUMMARY OF THE INVENTION

An object of the present invention is to provide an improved hand tool for use by backflow prevention technicians to accomplish with a single compact tool several functions that previously required a number of conventional tools, and to provide additional functionality to make testing and servicing backflow prevention devices easier.

In order to accomplish these and other objects of the invention, a multifunction hand tool is provided by the present invention to facilitate testing backflow prevention devices. The hand tool has a tubular body with first and second open ends, a front wall, a rear wall, and first and second side walls. A first screwdriver tip protrudes from the rear wall in a longitudinal direction so as to be coplanar with the rear wall. A second screwdriver tip protrudes from the front wall in a lateral direction so as to be perpendicular with the front wall. A socket opening is formed in the front wall for engaging a hexagon-shaped brass fitting. First and second slots are formed in the first and second side walls, respectively, for engaging a flat handle of a valve. A third slot is formed in the rear face for engaging a flat handle of a ball valve. A cutout portion in the tubular body is defined by a removed section of the front wall and the first and second side walls.

According to a broad aspect of the present invention, a multifunction hand tool is provided, comprising: a tubular body having first and second open ends, a front wall, a rear wall, and first and second side walls; a first screwdriver tip protruding from the rear wall; a second screwdriver tip protruding from the front wall, the first and second screwdriver tips being perpendicular relative to each other; a socket opening formed in the front wall for engaging a hexagon-shaped fitting; and first and second slots formed in the first and second side walls, respectively, for engaging a flat handle of a valve.

According to another broad aspect of the present invention, a multifunction hand tool is provided, comprising: a tubular body having first and second open ends, a front wall, a rear wall, and first and second side walls; a first screwdriver tip protruding from the rear wall in a longitudinal direction so as to be coplanar with the rear wall; a second screwdriver tip protruding from the front wall in a lateral direction so as to be perpendicular with the front wall; a socket opening formed in the front wall for engaging a hexagon-shaped fitting; first and second slots formed in the first and second side walls, respectively, for engaging a flat handle of a valve, the first and second slots being substantially aligned with each other to allow a flat handle of a valve to pass through the tubular body; and a third slot formed in the rear face for engaging a flat handle of a ball valve.

Numerous other objects and features of the present invention will be apparent to those skilled in this art from the following description wherein there is shown and described a preferred embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a front perspective view of a multifunction hand tool according to the present invention.

FIG. 2 is a rear perspective view of the multifunction hand tool shown in FIG. 1.

FIG. 3 is a plan view of the multifunction hand tool of the present invention.

FIG. 4 is a side view of the multifunction hand tool of the present invention.

FIG. 5 is an end view of the multifunction hand tool of the present invention.

FIG. 6 is a perspective view showing the multifunction hand tool being used to engage and turn a flat handle of a ball valve.

FIG. 7 is a perspective view showing the multifunction hand tool being used in another way to engage and turn a flat handle of a ball valve.

FIG. 8 is a perspective view showing the multifunction hand tool being used to engage and turn a stop cock of a backflow prevention valve.

FIG. 9 is a perspective view showing how the multifunction hand tool can be used to engage and turn a hex-shaped fitting.

### DETAILED DESCRIPTION OF THE PREFERRED EMBODIMENT

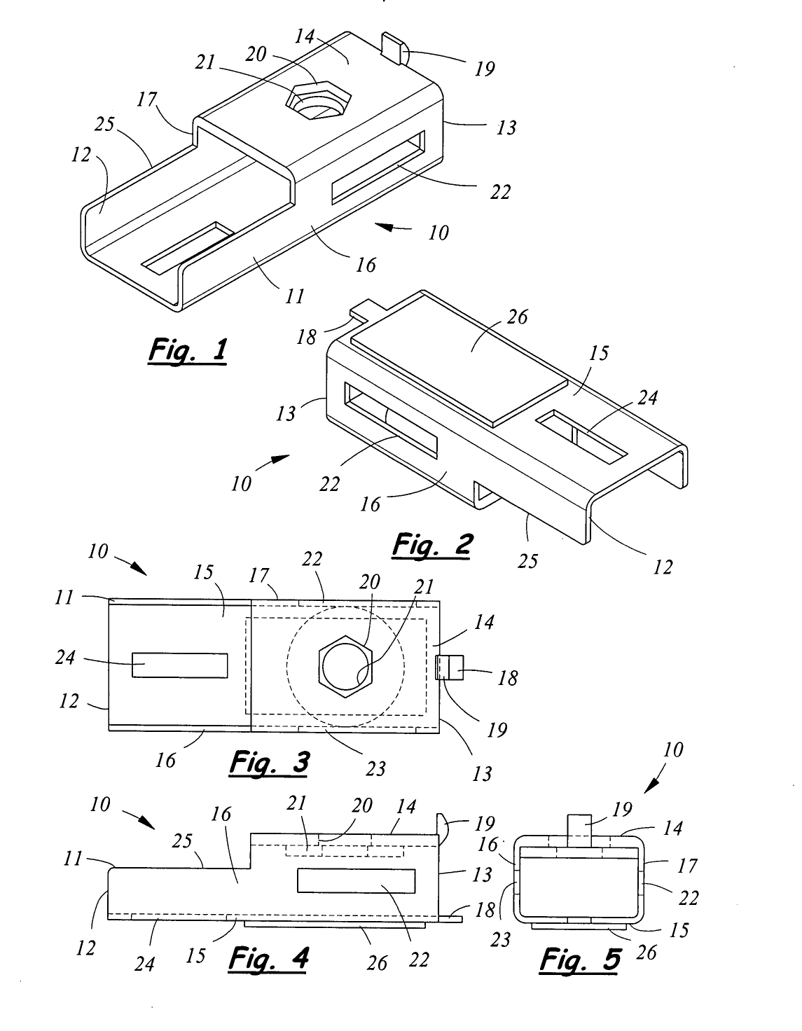

A multifunction hand tool 10 according to the present invention will now be explained in detail with reference to FIGS. 1 to 9 of the accompanying drawings.

The tool 10 includes a tubular body 11 having a first open end 12, a second open end 13, a front wall 14, a rear wall 15, and first and second side walls 16, 17. The tubular body 11 can be formed, for example, of a flat plate material, which is stamped and pressed into the desired shape. Alternatively, the tubular body 11 can be formed from pre-manufactured tubing or from an extruded or molded material. In the preferred embodiment, the tubular body 11 is formed of a metal plate material, which is stamped, pressed into the desired shape, and then welded (e.g., along one edge) to maintain its desired shape. The tubular body 11 in the preferred embodiment has a substantially rectangular cross section, as shown in FIG. 5.

A first screwdriver tip 18 is formed integral with the rear wall 15, and a second screwdriver tip 19 is formed integral with the front wall 14. The first and second screwdriver tips 18, 19 are preferably perpendicular relative to each other to provide the tool 10 with additional functionality. In the preferred embodiment, the first screwdriver tip 18 protrudes from the rear wall 15 in a longitudinal direction so as to be coplanar with the rear wall 15, and the second screwdriver tip 19 protrudes from the front wall 14 in a lateral direction so as to be perpendicular with the front wall 14. The screwdriver tips 18, 19 are shaped like standard flat screwdriver tips.

A socket opening 20 is formed in the front wall 14 for engaging hexagon-shaped fittings, such as common brass fittings used with backflow prevention devices. The socket opening 20 is a multi-sided opening (preferably 6-sided, but other multiples of 6 are also possible) in a size most likely to be encountered by the user. A washer 21 is fixed to a bottom side of the front face 14 in a position that is coaxial with the multi-sided socket opening 20. The washer 21 provides a means for preventing movement of a hexagon-shaped fitting into the socket opening 20 past a maximum desired depth. The washer 21 also serves to receive the tapered part of a flared brass fitting, which can help align the fitting with the hexagon-shaped portion of the socket opening 20. Other constructions for the socket opening 20 are also possible, such as attaching a standard socket to the front wall 14, or forming both the socket opening 20 and the washer 21 as integral parts of the front wall 14 of the tubular body 11.

First and second slots 22, 23 are formed in the first and second side walls 16, 17 of the tubular body 11, respectively. The first and second slots 22, 23 provide means for engaging a flat handle of a ball valve, as shown in FIG. 7. The slots 22, 23 are substantially rectangular and extend in a longitudinal direction along the tubular body 11. The first and second slots 22, 23 are substantially aligned with each other on opposite sides of the tubular body 11 to allow a flat handle of a valve to pass through the tubular body 11.

A third slot 24 is formed in the rear face 15 of the tubular body 11. The third slot 24 can also be used to engage a flat handle of a ball valve to give the tool 10 additional functionality. For example, in certain applications, the third slot 24 can be used to engage and turn a flat handle of a ball valve easier than the first and second slots 22, 23 or the other parts of the tool 10.

The tubular body 11 has a cutout portion 25 extending from the first open end 12 to an intermediate point between the first and second open ends 12, 13. The cutout portion 25 is defined by a removed section of the front wall 14 and the first and second side walls 16, 17. Since the tubular body 11 has a rectangular cross section, the first and second side walls 16, 17 face each other on opposite sides of the cutout portion 25 and can be used to engage and rotate parts of a backflow prevention device (e.g., ball valve handles, retainer clips, etc.).

The cutout portion 25 can be used to allow the tool 10 to fit over and turn a flat handle of a ball valve in certain conditions when other techniques fail. The cutout portion 25 will allow the tool 10 to be slid further over the flat handle of a ball valve so that the pivot point for the flat handle is located within the cutout portion 25 between the first and second side walls 16, 17. This allows additional leverage to be exerted on the flat handle and can sometimes help prevent a handle of a stuck valve from bending instead of turning the valve. In addition, the cutout portion 25 is located on an opposite side of the tubular body 11 from the third slot 24, which gives the tool 10 additional functionality. Because there is no wall opposite the third slot 24, the third slot 24 offers a different and sometimes quite useful mode of engaging the flat handle of a ball valve other than what is provided by the first and second slots 22, 23 or the hollow interior of the tubular body 11 itself.

A magnet 26 is provided on the rear wall 15 of the tubular body 11. The magnet 26 provides a means of attaching the hand tool 10 to a metal surface, such as a tool box or a work surface near the plumbing device being tested. The magnet 26 can be a flat member that covers a substantial portion of the outside surface of the rear wall 15, as shown in FIG. 2. Alternatively, the magnet 26 can be provided in other forms, such as a plurality of smaller magnet members or magnets that are mounted in recesses formed in the rear wall.

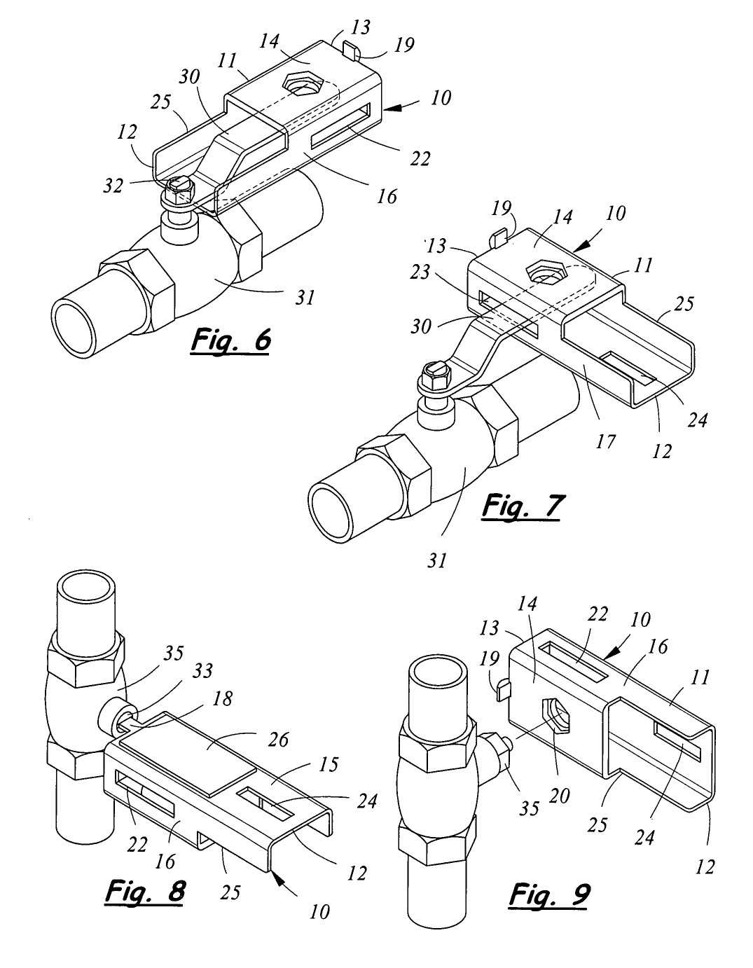

The multifunction tool 10 of the present invention can be used in a variety of ways, some of which are illustrated in FIGS. 6 to 9. For example, the tool 10 can be used to engage and turn a flat handle 30 of a ball valve 31 by (1) positioning the flat handle 30 within the hollow interior of the tubular body 11, as shown in FIG. 6; (2) positioning the flat handle 30 within the hollow interior of the tubular body 11 with the tubular body 11 turned upside down from what is shown in FIG. 6 so that the pivot point 32 of the handle 30 is positioned within the cutout portion 25; (3) positioning the flat handle 30 through the first and second slots 22, 23, as shown in FIG. 7; (4) positioning the flat handle 30 through the third slot 24; or (5) inserting the flat handle 30 through the second open end 13 of the tubular body 11.

As shown in FIG. 8, the first screwdriver tip 18 can be used to engage and rotate a stop cock 33 of a backflow prevention device 34. However, in certain circumstances, it is not possible or convenient to use a long screwdriver in the manner shown in FIG. 8, and the angled second screwdriver tip 19 can be used instead. The screwdriver tips 18, 19 can also be used to engage and rotate things other than stop cocks, such as screws and the like.

As shown in FIG. 9, the socket opening 20 of the tool 10 can be used to engage and rotate a hexagon-shaped fitting 35, such as the flared brass fittings commonly used with backflow prevention devices.

The tool can also be used to remove and reinstall metal retainer clips that are used in backflow prevention devices to hold down the spring and bottom check valve. In this case, the open portion of the sidewalls 16, 17 exposed by the cutout portion 25 can be used to engage and turn the retainer clip (i.e., with the retainer clip between the sidewalls 16, 17).

The tool can also be used to pry lids off of standard valve boxes that are used to house backflow devices and other types of valves underground. In this case, the screwdriver tips 18 and 19 are used to either pry the lid off the valve box or to disengage a plastic latch on the valve box to release the lid.

The particular arrangement of the multifunction hand tool 10 of the present invention provides a tool that is highly functional and useful for testing and servicing backflow prevention devices, as well as a variety of other plumbing and service applications.

While the invention has been specifically described in connection with specific embodiments thereof, it is to be understood that this is by way of illustration and not of limitation, and the scope of the appended claims should be construed as broadly as the prior art will permit.

What is claimed is:

1. A multifunction hand tool, comprising:
a tubular body having first and second open ends, a front wall, a rear wall, and first and second side walls;
a first screwdriver tip protruding from said rear wall;
a second screwdriver tip protruding from said front wall, said first and second screwdriver tips being perpendicular relative to each other;
a socket opening formed in said front wall for engaging a hexagon-shaped fitting; and
first and second slots formed in said first and second side walls, respectively, for engaging a flat handle of a valve.

2. The multifunction hand tool according to claim 1, further comprising a third slot formed in said rear face for engaging a flat handle of a ball valve.

3. The multifunction hand tool according to claim 1, wherein said tubular body has a cutout portion extending from said first open end to an intermediate point between said first and second open ends, said cutout portion being defined by a removed section of said front wall and said first and second side walls.

4. The multifunction hand tool according to claim 3, wherein said first and second screwdriver tips protrude from said second open end of said tubular body.

5. The multifunction hand tool according to claim 4, wherein said first and second slots are located between said second open end and said cutout portion.

6. The multifunction hand tool according to claim 5, further comprising a third slot formed in said rear face for engaging a flat handle of a ball valve, said third slot being formed on an opposite side of said tubular body from said cutout portion.

7. The multifunction hand tool according to claim 1, wherein said socket opening comprises a multi-sided opening with a means on the bottom side of the opening for preventing movement of a hexagon-shaped fitting into the socket opening past a maximum desired depth.

8. The multifunction hand tool according to claim 7, wherein said means for preventing movement comprises a washer fixed to a bottom side of said front face, said washer being coaxial with said multi-sided opening.

9. The multifunction hand tool according to claim 1, wherein said first screwdriver tip protrudes from said rear wall in a longitudinal direction so as to be coplanar with said rear wall.

10. The multifunction hand tool according to claim 9, wherein said second screwdriver tip protrudes from said front wall in a lateral direction so as to be perpendicular with said front wall.

11. The multifunction hand tool according to claim 1, further comprising a magnet secured to said rear wall for attaching the hand tool to a metal surface.

12. A multifunction hand tool, comprising:
a tubular body having first and second open ends, a front wall, a rear wall, and first and second side walls;
a first screwdriver tip protruding from said rear wall in a longitudinal direction so as to be coplanar with said rear wall;
a second screwdriver tip protruding from said front wall in a lateral direction so as to be perpendicular with said front wall;
a socket opening formed in said tubular body for engaging a hexagon-shaped fitting; and
first and second slots formed in said first and second side walls, respectively, for engaging a flat handle of a valve, said first and second slots being substantially aligned with each other to allow a flat handle of a valve to pass through said tubular body.

13. The multifunction hand tool according to claim 12, wherein said tubular body has a substantially rectangular cross section with a cutout portion extending from said first open end to an intermediate point between said first and second open ends, said cutout portion being defined by a removed section of said front wall and said first and second side walls.

14. The multifunction hand tool according to claim 13, wherein said first and second screwdriver tips protrude from said second open end of said tubular body.

15. The multifunction hand tool according to claim 14, wherein said first and second slots are located between said second open end and said cutout portion.

16. The multifunction hand tool according to claim 15, further comprising a third slot formed in said rear face for engaging a flat handle of a ball valve, said third slot being formed on an opposite side of said tubular body from said cutout portion.

17. The multifunction hand tool according to claim 12, wherein said socket opening comprises a multi-sided opening with a means on the bottom side of the opening for preventing movement of a hexagon-shaped fitting into the socket opening past a maximum desired depth.

18. The multifunction hand tool according to claim 17, wherein said means for preventing movement comprises a washer fixed to a bottom side of said front face, said washer being coaxial with said multi-sided opening.

19. The multifunction hand tool according to claim 12, further comprising a magnet secured to said rear wall for attaching the hand tool to a metal surface.

20. The multifunction hand tool according to claim 12, wherein said first, second and third slots are substantially rectangular and extend in a longitudinal direction along said tubular body.
